(19) United States
(12) Patent Application Publication
(10) Pub. No.: US 2024/0036889 A1
(43) Pub. Date: Feb. 1, 2024

(54) METHOD FOR PROVIDING OBJECT-ORIENTED APPLICATION EXECUTION INTERFACE, SERVICE SERVER FOR PERFORMING SAME, AND COMPUTER-READABLE MEDIUM THEREOF

(71) Applicant: KONGTECH CO., LTD., Seongnam-si (KR)

(72) Inventor: Hak Kyung LEE, Seongnam-si (KR)

(21) Appl. No.: 18/358,122

(22) Filed: Jul. 25, 2023

(30) Foreign Application Priority Data
Jul. 27, 2022 (KR) 10-2022-0093180

(51) Int. Cl. G06F 9/451; G06F 3/04815; G06F 3/0482; G06T 19/00

(52) U.S. Cl. CPC G06F 9/451; G06F 3/04815; G06F 3/0482; G06T 19/00; G06T 2200/24

(57) ABSTRACT

The present invention relates to a method for providing an object-oriented application execution interface, a service server for performing the same, and a computer-readable medium thereof, wherein object-oriented service information is provided differently from a conventional configuration of providing application-oriented service information in an operating system in smart phone, PC, etc. by receiving reality information on each of real objects in reality, projecting virtual objects generated based on the reality information on 3D map, providing a map interface including the 3D map to a user terminal, deriving app list information on one or more applications related to a specific virtual object to provide to the user terminal when selecting the virtual object on a map interface displayed in the user terminal, and executing any one application to derive service information on the selected virtual object and provide to the user terminal when selecting the corresponding application included in app list.

### TECHNICAL FIELD

The present invention relates to a method for providing an object-oriented application execution interface, a service server for performing the same, and a computer-readable medium thereof, and more specifically, to a method for providing an object-oriented application execution interface, a service server for performing the same, and a computer-readable medium thereof, in which object-oriented service information is provided differently from a configuration of providing application-oriented service information in an operating system driven in a smart phone, PC, etc., in the related art by receiving reality information on each of a plurality of reality objects in reality, projecting virtual objects generated based on the reality information on a 3D map, providing a map interface including the 3D map to a user terminal, deriving app list information on one or more applications related to a specific virtual object to provide the same to the user terminal when a user selects the virtual object on a map interface displayed in the user terminal, and executing any one application to derive service information on the selected virtual object and provide the same to the user terminal when the user selects the corresponding application included in an app list.

### BACKGROUND ART

With recent implementation of various services on an online basis, not only traditional computing devices such as a personal computer (PC) but also mobile devices such as a smart phone or a tablet PC have been so widely distributed that such electronic devices have become a very important and indispensable item in daily life.

Meanwhile, in the case of an operating system which is driven in devices such as a PC, a smart phone, or the like, in the related art as described above, a wallpaper (main screen) is shown after the operating system is initially driven or a lock screen is unlocked, and a graphic element (icon) for executing one or more application programs (application) installed in the device by a user is shown on the wallpaper.

In general, the user may select any one icon from among one or more icons shown on the wallpaper to execute an application corresponding to the selected icon, and select an object, which is processable in the corresponding application, from the executed application, so as to receive a processing result of the corresponding application for the selected object. In other words, in the related art, the user is provided with the processing result for the object based on the application.

For example, the user may execute a moving image reproducing application and select a moving image file (object) which may be reproduced in the corresponding application, thereby having the corresponding moving image file reproduced as a processing result of the moving image reproducing application. In addition, the user may execute a food ordering application and select a food or a restaurant (object) shown in the corresponding application, thereby placing an order for a specific food in a specific restaurant as a processing result of the food ordering application.

Meanwhile, as described above, various services are applied to one object as various services are implemented on an online basis. Accordingly, in the case of the conventional application-oriented service providing method, the user has to execute an application for receiving a corresponding service by determining which service is to be provided first, and thus there is a problem that the conventional service is not suitable for a method of selecting an object first and then selecting a service related to the object.

Thus, it is necessary to develop a new interface for providing a service not based on a conventional application, but based on an object, and in particular, it is essential to develop a new interface providing method for providing an object-oriented service in the case of a service such as a digital twin, a metaverse, or the like, in which various objects are displayed in a device.

### SUMMARY OF THE INVENTION

### Technical Problem

An object of the present invention is to provide a method for providing an object-oriented application execution interface, a service server for performing the same, and a computer-readable medium thereof, and more specifically, to provide a method for providing an object-oriented application execution interface, a service server for performing the same, and a computer-readable medium thereof, in which object-oriented service information is provided differently from a configuration of providing application-oriented service information in an operating system driven in a smart phone, PC, etc., in the related art by receiving reality information on each of a plurality of reality objects in reality, projecting virtual objects generated based on the reality information on a 3D map, providing a map interface including the 3D map to a user terminal, deriving app list information on one or more applications related to a specific virtual object to provide the same to the user terminal when a user selects the virtual object on a map interface displayed in the user terminal, and executing any one application to derive service information on the selected virtual object and provide the same to the user terminal when the user selects the corresponding application included in an app list.

### Technical Solution

To solve the above object, in one embodiment of the present invention, there may be provided a method for providing an object-oriented application execution interface, which is performed in a service server including one or more processors and one or more memories, the method including: a reality information receiving step of receiving reality information on each of a plurality of reality objects from the plurality of reality objects in reality or an external system communicating with the plurality of reality objects; a map interface providing step of providing a user terminal with a map interface in which a virtual object reflecting a shape and location of the reality object is shown on a 3D map based on reality information on each of the corresponding reality objects; an app list layer providing step of deriving app list information on one or more applications connected to any one selected virtual object and providing the user terminal with an app list layer including the app list information, when the virtual object shown on the map interface displayed in the user terminal; and a service information providing step of executing any one application when the selected application is selected on the app list layer displayed in the user terminal through the app list layer providing step.

In one embodiment of the present invention, the app list layer providing step may derive the app list information on one or more applications determined based on property of the selected virtual object among a plurality of applications usable in the user terminal.

In one embodiment of the present invention, the app list layer providing step may show the app list layer including the derived app list information on a 3D map of the map interface displayed in the user terminal while overlaying the app list layer.

In one embodiment of the present invention, the service information providing step may include: a service layer providing step of executing the selected application to derive service information for the selected virtual object and provide a service layer including the service information to the user terminal, in which the service layer may be shown on the map interface displayed in the user terminal while overlaying the service layer.

In one embodiment of the present invention, the app list layer may include: an execution proposal area configured to show a list of one or more applications set from the user terminal among the one or more applications connected to the selected virtual object; and an installation proposal area configured to show a list of one or more applications not set from the user terminal among the one or more applications connected to the selected virtual object.

In one embodiment of the present invention, the map interface may show a predetermined area determined according to a user's input in the user terminal on the 3D map, and the 3D map with the predetermined area shown thereon may show movements of one or more virtual objects corresponding to one or more reality objects in real time based on the reality information on the one or more reality objects which move or enter in a real space corresponding to the predetermined area.

In one embodiment of the present invention, the map interface providing step may include: an indoor interface providing step of providing the user terminal with an indoor interface for indicating an inside of any one virtual object having a building property when the any one virtual object having the building property is selected on the 3D map of the map interface displayed in the user terminal and entry for the any one virtual object having the building property is input, in which the indoor interface may be configured to show one or more detailed virtual objects corresponding to one or more detailed reality objects included inside a reality object corresponding to any one virtual object having the building property.

To solve the above object, in one embodiment of the present invention, there may be provided a service server for performing an object-oriented application execution interface, including one or more processors and one or more memories, in which the service server performs: a reality information receiving step of receiving reality information on each of a plurality of reality objects from the plurality of reality objects in reality or from an external system communicating with the plurality of reality objects; a map interface providing step of providing a user terminal with a map interface in which a virtual object reflecting a shape and location of the reality object is shown on a 3D map based on reality information on each of the corresponding reality objects; an app list layer providing step of deriving app list information on one or more applications connected to any one selected virtual object and providing the user terminal with an app list layer including the app list information, when the virtual object shown on the map interface displayed in the user terminal; and a service information providing step of executing any one application when the selected application is selected on the app list layer displayed in the user terminal through the app list layer providing step.

To solve the above object, in one embodiment of the present invention, there may be provided a computer-readable medium method for implementing an object-oriented application execution interface, which is performed in a service server including one or more processors and one or more memories, in which the computer-readable medium may include computer-executable instructions for causing the service server to perform steps as follows: a reality information receiving step of receiving reality information on each of a plurality of reality objects from the plurality of reality objects in reality or an external system communicating with the plurality of reality objects; a map interface providing step of providing a user terminal with a map interface in which a virtual object reflecting a shape and location of the reality object is shown on a 3D map based on reality information on each of the corresponding reality objects; an app list layer providing step of deriving app list information on one or more applications connected to any one selected virtual object and providing the user terminal with an app list layer including the app list information, when the virtual object shown on the map interface displayed in the user terminal; and a service information providing step of executing any one application when the selected application is selected on the app list layer displayed in the user terminal through the app list layer providing step.

### Advantageous Effects

According to one embodiment of the present invention, when a virtual object shown on a 3D map of a map interface is selected, an app list layer, in which app list information on one or more applications connected to the selected virtual object is shown, can be provided to a user terminal so as to be displayed, thereby exhibiting an effect of providing a service according to the execution of an application on the basis of the object.

According to one embodiment of the present invention, reality information on a plurality of reality objects in reality can be received, virtual objects corresponding to the reality objects can be generated according to the reality information and shown on the 3D map, and the shapes and locations of the reality objects included in the reality information can be reflected on the 3D map, thereby exhibiting an effect of allowing a user using the 3D map to feel a sense of reality.

According to one embodiment of the present invention, the app list layer providing step can show the app list layer on the 3D map of the map interface displayed in the user terminal while overlaying the app list, thereby exhibiting an effect of allowing the user to more conveniently recognize the virtual object shown on the 3D map of the map interface and the app list layer for the corresponding virtual object.

According to one embodiment of the present invention, the service information providing step can execute a selected application to derive service information on the selected virtual object and overlay a service layer including the service information onto the map interface displayed in the user terminal, when any one application shown on the app list layer is selected, thereby exhibiting an effect of performing all the processes of allowing the user to select a virtual object on the map interface, select any one application related to the virtual object, and receive the service information.

According to one embodiment of the present invention, the app list layer can include an installation proposal area which shows one or more applications, which are not installed in the user terminal, from among one or more applications connected to the selected virtual object, thereby exhibiting an effect of being recommended an application which is not installed in the user terminal among one or more applications connected to the virtual object selected by the user.

According to one embodiment of the present invention, the map interface providing step can show an indoor interface for an inside of a selected virtual object and a detailed virtual object included therein, when a virtual object having a building property is selected on a 3D map and an entry for the virtual object is input, thereby exhibiting an effect of allowing the user to see an inside of the building selected by the user and the objects contained therein.

### DESCRIPTION OF DRAWINGS

FIG. 1 schematically shows components for performing a method of providing an object-oriented application execution interface according to one embodiment of the present invention.

FIGS. 2A, 2B and 2C schematically show a virtual object shown on a 3D map according to reality information which is received in a reality information receiving step according to one embodiment of the present invention.

FIG. 3 schematically shows detailed steps of a method of providing an object-oriented application execution interface according to one embodiment of the present invention.

FIGS. 4A and 4B schematically illustrate one or more applications connected to the virtual object according to a property assigned to the virtual object according to one embodiment of the present invention.

FIGS. 5A and 5B schematically show a map interface displayed in a user terminal according to one embodiment of the present invention.

FIGS. 6A and 6B schematically show an app store layer displayed in a user terminal according to a user's input on a map interface according to one embodiment of the present invention.

FIG. 7 schematically shows an object information layer for any one virtual object displayed in a user terminal when the corresponding virtual object shown on a 3D map of a map interface is selected, according to one embodiment of the present invention.

FIG. 8 schematically shows an app list layer for any one virtual object displayed in a user terminal when the corresponding virtual object shown on a 3D map of a map interface is selected, according to one embodiment of the present invention.

FIGS. 9A and 9B schematically show a service layer displayed in a user terminal through a service information providing step according to one embodiment of the present invention.

FIG. 10 schematically shows an indoor interface displayed in a user terminal through an indoor interface providing step according to one embodiment of the present invention.

FIGS. 11A and 11B schematically show a virtual object shown on a 3D map of a map interface displayed in a user terminal according to one embodiment of the present invention.

FIGS. 12A and 12B schematically show a virtual object shown on a 3D map of an indoor interface and a map interface displayed in a user terminal according to one embodiment of the present invention.

FIG. 13 schematically shows internal components of the computing device according to one embodiment of the present invention.

### DETAILED DESCRIPTION OF THE EXEMPLARY EMBODIMENTS

Hereinafter, various embodiments and/or aspects will be described with reference to the drawings. In the following description, numerous specific details are set forth in order to provide a thorough understanding of one or more aspects for the purpose of explanation. However, it will also be appreciated by a person having ordinary skill in the art that such aspect(s) may be carried out without the specific details. The following description and accompanying drawings will be set forth in detail for specific illustrative aspects among one or more aspects. However, the aspects are merely illustrative, some of various ways among principles of the various aspects may be employed, and the descriptions set forth herein are intended to include all the various aspects and equivalents thereof.

In addition, various aspects and features will be presented by a system that may include a plurality of devices, components and/or modules or the like. It will also be understood and appreciated that various systems may include additional devices, components and/or modules or the like, and/or may not include all the devices, components, modules or the like recited with reference to the drawings.

The term “embodiment”, “example”, “aspect”, “exemplification”, or the like as used herein may not be construed in that an aspect or design set forth herein is preferable or advantageous than other aspects or designs. The terms ‘unit’, ‘component’, ‘module’, ‘system’, ‘interface’ or the like used in the following generally refer to a computer-related entity, and may refer to, for example, hardware, software, or a combination of hardware and software.

In addition, the terms “include” and/or “comprise” specify the presence of the corresponding feature and/or component, but do not preclude the possibility of the presence or addition of one or more other features, components or combinations thereof.

In addition, the terms including an ordinal number such as first and second may be used to describe various components, however, the components are not limited by the terms. The terms are used only for the purpose of distinguishing one component from another component. For example, the first component may be referred to as the second component without departing from the scope of the present invention, and similarly, the second component may also be referred to as the first component. The term “and/or” includes any one of a plurality of related listed items or a combination thereof.

In addition, in embodiments of the present invention, unless defined otherwise, all terms used herein including technical or scientific terms have the same meaning as commonly understood by those having ordinary skill in the art. Terms such as those defined in generally used dictionaries will be interpreted to have the meaning consistent with the meaning in the context of the related art, and will not be interpreted as an ideal or excessively formal meaning unless expressly defined in the embodiment of the present invention.

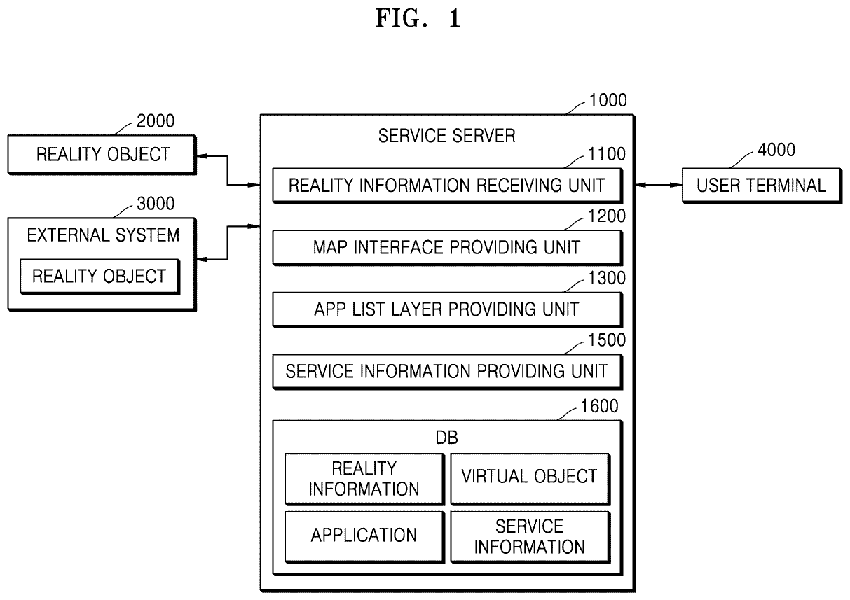

FIG. 1 schematically shows components for performing a method of providing an object-oriented application execution interface according to one embodiment of the present invention.

As shown in FIG. 1, a service server 1000 may perform a method of providing an object-oriented application execution interface of the present invention by communicating with a plurality of reality objects 2000 or an external system 3000 and a user terminal 4000 communicating with the plurality of reality objects 2000.

Specifically, the service server 1000 may include a reality information receiving unit 1100, a map interface providing unit 1200, an app list layer providing unit 1300, a service information providing unit 1500, and a DB 1600 in order to perform the method of providing an object-oriented application execution interface of the present invention.

The reality information receiving unit 1100, which is configured to perform a reality information receiving step S100, may receive reality information on each reality object 2000 from a plurality of reality objects 2000 located in a real space, or may include the plurality of reality objects 2000, or may receive reality information on each of the plurality of reality objects 2000 from the external system 3000 which communicates with the plurality of reality objects 2000. In other words, the reality information receiving unit 1100 may directly receive reality information from the plurality of reality objects 2000 or indirectly receive reality information from the external system 3000. In addition, the reality information receiving unit 1100 may not only receive the reality information from the reality objects 2000 or the external system 3000 only once, but also continuously receive the reality information in real time or according to a preset period.

The map interface providing unit 1200, which is configured to perform a map interface providing step S200, may generate a virtual object for the reality object 2000 corresponding to the reality information based on the corresponding reality information received by the real information receiving unit 1100, and may show the generated virtual object on the 3D map. In this case, the virtual object may be generated based on shape information of the reality object 2000 included in the reality information, and the virtual object may be projected at a predetermined location on the 3D map corresponding to a location of the reality object 2000 based on location information of the reality object 2000 further included in the reality information. Meanwhile, the map interface providing unit 1200 may provide the user terminal 4000 with a map interface L1 including a 3D map onto which the virtual object is projected, and the user terminal 4000 receiving the map interface L1 may show the map interface L1 on a display of the user terminal 4000. In addition, even after providing the map interface L1 to the user terminal 4000, the map interface providing unit 1200 may continuously provide the user terminal 4000 with the map interface L1 in which a location of the virtual object on the 3D map is changed according to the location information included in the continuously received reality information in real time or in each predetermined period.

The app list layer providing unit 1300, which is configured to perform the app list layer providing step S300, may have the user terminal 4000 transfer to the service server 1000 that any one virtual object is selected, when the user selects any one virtual object projected onto the 3D map on the map interface L1 displayed in the user terminal 4000 through the map interface providing unit 1200, and the app list layer providing unit 1300 of the service server 1000 may derive app list information corresponding to a list for one or more predetermined applications with respect to the selected virtual object, may provide to the user terminal 4000 with an app list layer L4 on which the app list information is shown, and may display the app list layer L4 on the user terminal 4000.

The service information providing unit 1500, which is configured to perform the service providing step, may have the user terminal 4000 transfer to the service server 1000 that any one application is selected, when the any one application is selected on the app list layer L4 displayed in the user terminal 4000 through the service information providing unit 1500, and the service information providing unit 1500 of the service server 1000 may execute the selected application to generate service information for the selected virtual object and provide the generated service information to the user terminal 4000.

Meanwhile, the DB 1600 included in the service server 1000 may be configured to store information received or generated to perform a method of providing an object-oriented application execution interface of the present invention in the service server 1000. For example, the DB 1600 may be configured to store the reality information received by the reality information receiving unit 1100, the virtual object generated by the map interface providing unit 1200, one or more applications preset for the virtual object, the service information generated by the service information providing unit 1500, and the like.

The reality object 2000 may refer to various objects included in the real space. For example, the reality object 2000 may correspond to a transportation, a building, a structure, a device, facility or the like disposed in the building, the structure, or the like, and a person may also correspond to the reality object 2000. Meanwhile, the reality object 2000 may include or be attached with elements such as one or more sensors, a GPS, or the like to sense an environment or motion around the reality object 2000 or measure a location of the reality object 2000, and such information may be included in the reality information and thus received by the reality information receiving unit 1100 of the service server 1000. In addition, when the reality object 2000 corresponds to the above-described device, facility or the like, the reality information on the corresponding object may include an operation result according to an operation of the device, facility or the like.

The reality information may be directly transmitted from the reality object 2000 to the reality information receiving unit 1100 of the service server 1000, but may be indirectly transmitted through the external system 3000 as described above. In this case, the external system 3000 may communicate with the reality object 2000 to receive the reality information generated by the reality object 2000, and transmit the received reality information to the reality information receiving unit 1100. Specifically, the external system 3000 may correspond to an external server separate from the service server 1000 of the present invention, or may correspond to a gateway or a relay.

Meanwhile, the user terminal 4000 may correspond to a computing device in which a user who wants to receive various services through the map interface L1 provided by the service server 1000 becomes a user subject. In addition, a separate application for performing communication with the service server 1000 may be installed in the user terminal 4000, or communication with the service server 1000 may be performed through a separate web page implemented through a web browser installed in the user terminal 4000.

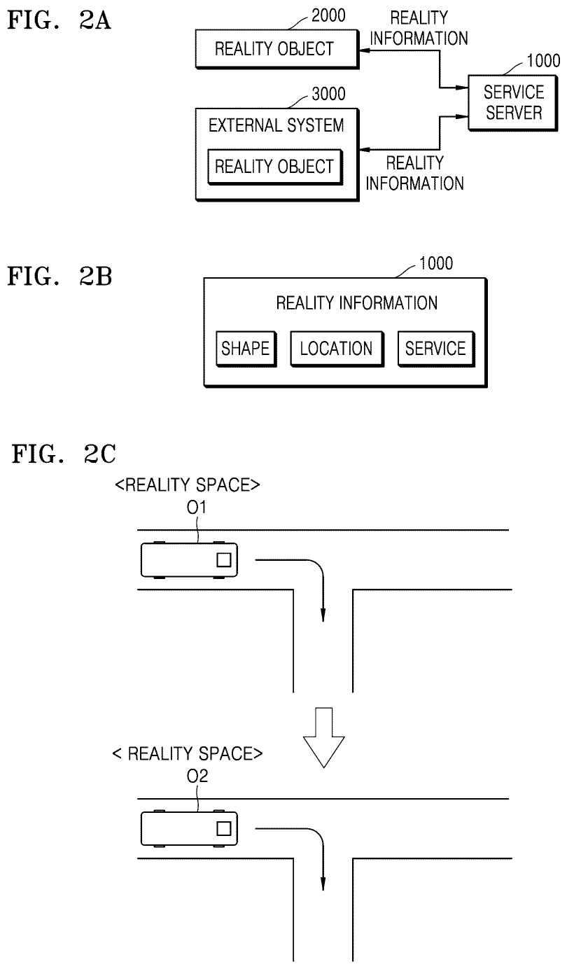

FIGS. 2A, 2B and 2C schematically show a virtual object shown on a 3D map according to reality information which is received in a reality information receiving step according to one embodiment of the present invention.

As shown in FIG. 2A, the service server 1000, specifically, the reality information receiving unit 1100 included in the service server 1000, may perform the reality information receiving step S100 to receive reality information on each of the plurality of reality objects 2000 from the plurality of reality objects 2000 or the external system 3000 communicating with the plurality of reality objects 2000.

In this case, as shown in FIG. 2B, the reality information received by the reality information receiving step S100 may include shape information, location information, and service information on the corresponding reality object 2000.

The shape information may be configured to implement a shape of the virtual object when generating the virtual object corresponding to the corresponding reality object 2000. For example, when the reality object 2000 is a building, the shape information may include an area, a height, and the like of the building, and accordingly, the virtual object for the reality object 2000 may be generated in a form of reflecting the shape information.

The location information may refer to information on the location of the corresponding reality object 2000, and may correspond to information for locating a virtual object corresponding to the corresponding reality object 2000 on the 3D map. For example, when the corresponding reality object 2000 is located at 123-4A-dong, a virtual object for the corresponding reality object 2000 may also be projected at 123-4A-dong on the 3D map. Meanwhile, when the corresponding reality object 2000 is fixedly located such as a building, the location information may be included only in the reality information initially received by the reality information receiving unit 1100, and may not be included in the reality information on the corresponding reality object 2000 received later. On the contrary, when the location of the reality object 2000 varies over time, such as a person or a transportation, the reality information on the corresponding reality object 2000 continuously received by the reality information receiving unit 1100 may include the location information corresponding to the location of the corresponding reality object 2000 at a time when the reality information is generated.

The service information may include information obtained by sensing an operation of a surrounding environment or the reality object 2000 through one or more sensors included or disposed in the corresponding reality object 2000, or may include information on an operation result according to an operation of the corresponding reality object 2000. Meanwhile, when a virtual object shown on the 3D map of the map interface L1 displayed in the user terminal 4000 is selected by the user, the service information included in the reality information on the corresponding virtual object may be shown in the user terminal 4000 as it is. When the virtual object shown on the 3D map of the map interface L1 displayed in the user terminal 4000 is selected by the user and an application for the corresponding virtual object is selected, the selected application may be executed to generate new service information based on the service information of the reality information corresponding to the selected virtual object.

In the meantime, the map interface providing step S200 may be configured to generate a virtual object corresponding to the reality object 2000 in which the corresponding reality information is transmitted based on the reality information received in the reality information receiving step S100, and project and show the generated virtual object at a predetermined location of the 3D map as shown in FIG. 2C. For example, as shown in FIG. 2C, when the location of the reality object O1 is changed by going straight on a road in a real space and then turning right at an intersection, the location of the virtual object O2 with respect to the reality object O1 may also be changed in the same manner on the 3D map based on the reality information of the reality object O1. For this purpose, the reality information receiving step S100 may be configured to continuously receive the reality information of the corresponding reality object O1 in real time or according to a preset period.

As described above, in the present invention, the virtual object having the same shape as that of the reality object 2000 may be shown on the 3D map in the same manner as a change in the location of the reality object 2000 according to the reality information of the reality object 2000, and thus the reality object 2000 in the real space may be implemented as the virtual object on the 3D map corresponding to the virtual space.

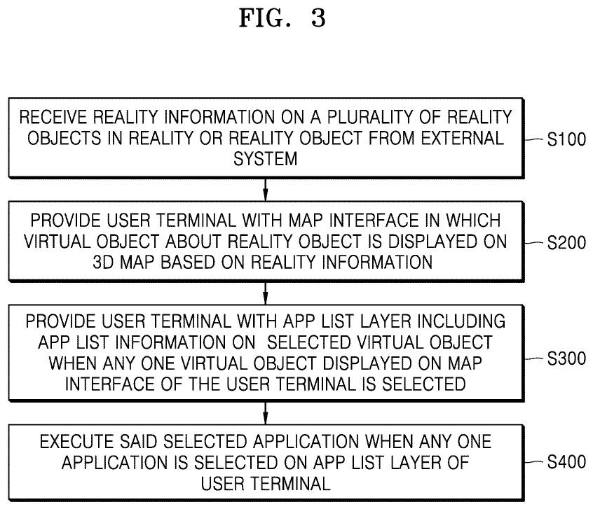

FIG. 3 schematically shows detailed steps of a method of providing an object-oriented application execution interface according to one embodiment of the present invention.

As shown in FIG. 3, there may be provided a method for providing an object-oriented application execution interface, which is performed in a service server 1000 including one or more processors and one or more memories, the method comprising: a reality information receiving step S100 of receiving reality information on each of a plurality of reality objects 2000 in reality or from an external system 3000 communicating with the plurality of reality objects 2000; a map interface providing step S200 of providing a user terminal 4000 with a map interface L1 in which a virtual object reflecting a shape and location of the reality object 2000 is shown on a 3D map based on reality information on each of the corresponding reality objects 2000; an app list layer providing step S300 of deriving app list information on one or more applications connected to any one selected virtual object and providing the user terminal 4000 with an app list layer L4 including the app list information, when the virtual object shown on the map interface L1 displayed in the user terminal 4000; and a service information providing step S400 of executing any one application when the selected application is selected on the app list layer L4 displayed in the user terminal 4000 through the app list layer providing step S300.

Specifically, the reality information receiving step S100 may be configured to receive the reality information on each of the plurality of reality objects 2000 either directly or indirectly from the plurality of reality objects 2000 in reality. In addition, the reality information receiving step S100 may be configured not only to receive the reality information on the reality object 2000 only once, but also to continuously receive the reality information generated in real time or according to a predetermined period in the corresponding reality object 2000.

The map interface providing step S200 may be configured to generate a virtual object corresponding to the corresponding reality object 2000 based on the reality information received in the reality information receiving step S100, and project the virtual object on the 3D map based on the location information included in the reality information. Specifically, the 3D map may correspond to a three-dimensional map for the same geography as that of the reality, and the virtual object may be projected at a location corresponding to the location information on the 3D map based on the location information included in the reality information of the reality object 2000. Meanwhile, the 3D map on which the virtual object is projected may be included in the map interface L1, and the map interface L1 may be provided to the user terminal 4000, and thus the map interface L1 may be displayed on a screen of the user terminal 4000.

In addition, the map interface providing step S200 may be performed not only once, but also repeatedly in real time or according to a preset period. Specifically, when the location of the reality object 2000 is changed in real time or the operation result of the reality object 2000 corresponding to the service information included in the real information is updated, the repeatedly performed map interface providing step S200 may be configured to provide the user terminal 4000 with the map interface L1 including the 3D map in which the location of the virtual object corresponding to the reality object 2000 is changed in real time, or provide the user terminal 4000 with the map interface L1 to which the updated service information is applied.

When the user selects any one virtual object on the 3D map of the map interface L1 displayed in the user terminal 4000 through the above-described map interface providing step S200, the app list layer providing step S300 may be configured to derive app list information on a list of one or more applications connected to the selected virtual object, and provide the user terminal 4000 with an app list layer L4, on which the app list information is shown, so that the app list layer may be displayed. Through the app list layer L4 displayed in the user terminal 4000, the user may recognize which one or more applications are capable of providing a service related to the virtual object selected by the user, and may select any one application from among the one or more applications shown on the app list layer L4 so as to execute the selected application for the corresponding virtual object.

In the service providing step, when the user selects any one of the one or more applications shown on the app list layer L4 displayed in the user terminal 4000 through the app list layer providing step S300, the service information for the virtual object selected by the user may be derived by executing the selected any one application. Meanwhile, in deriving the service information by executing any one application selected by the user in the service providing step, separate service information may be derived using the service information included in the reality information corresponding to the selected virtual object.

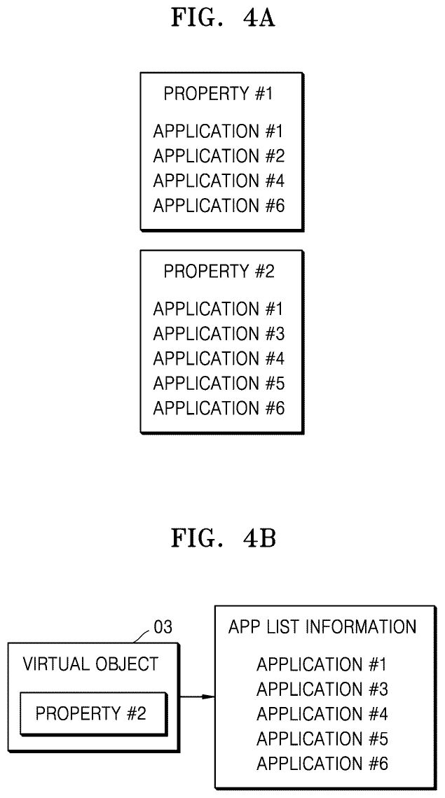

FIGS. 4A and 4B schematically illustrate one or more applications connected to the virtual object according to a property assigned to the virtual object according to one embodiment of the present invention.

As shown in FIGS. 4A and 4B, the app list layer providing step S300 may be configured to derive app list information on one or more applications determined based on the property of the selected virtual object among a plurality of applications usable in the user terminal 4000.

Specifically, the one or more applications connected to the virtual object may mean one or more applications preset for each of the one or more properties assigned to the virtual object. More specifically, as shown in FIG. 4A, one or more applications may be preset for each property which may be assigned to the virtual object in the service server 1000. For example, referring to FIG. 4A, a property #1 may include presetting of an application #1, an application #2, an application #4, and an application #6, and a property #2 may include presetting of an application #1, an application #3, an application #4, an application #5, and an application #6.

Meanwhile, when a virtual object is generated in the map interface providing step S200, one or more properties may be assigned to the corresponding virtual object. For example, when a virtual object for the reality object 2000 corresponding to subway is generated, a property of transportation and a property of public transportation may be given to the corresponding virtual object.

Accordingly, in the app list layer providing step S300, a list of one or more applications preset for the corresponding property may be derived as the app list information with respect to the property assigned to the virtual object selected by the user. For example, referring to FIG. 4B, if “property #2” is assigned to the virtual object O3 selected on the 3D map by the user, application #1, application #3, application #4, application #5, and application #6 preset for the “property #2” may be included in the app list information on the virtual object O3 selected by the user as shown in FIG. 4A.

As described above, the present invention may provide the user with a list of one or more applications capable of providing a service for the virtual object preferentially selected by the user in order to provide the service based on the object (virtual object), rather than providing the service based on the application, thereby exhibiting an effect of allowing the user to easily select the application.

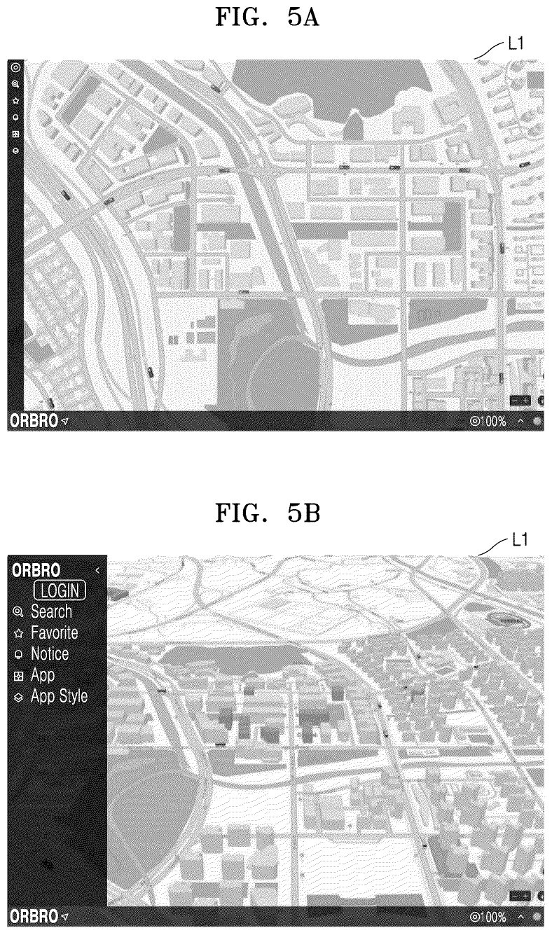

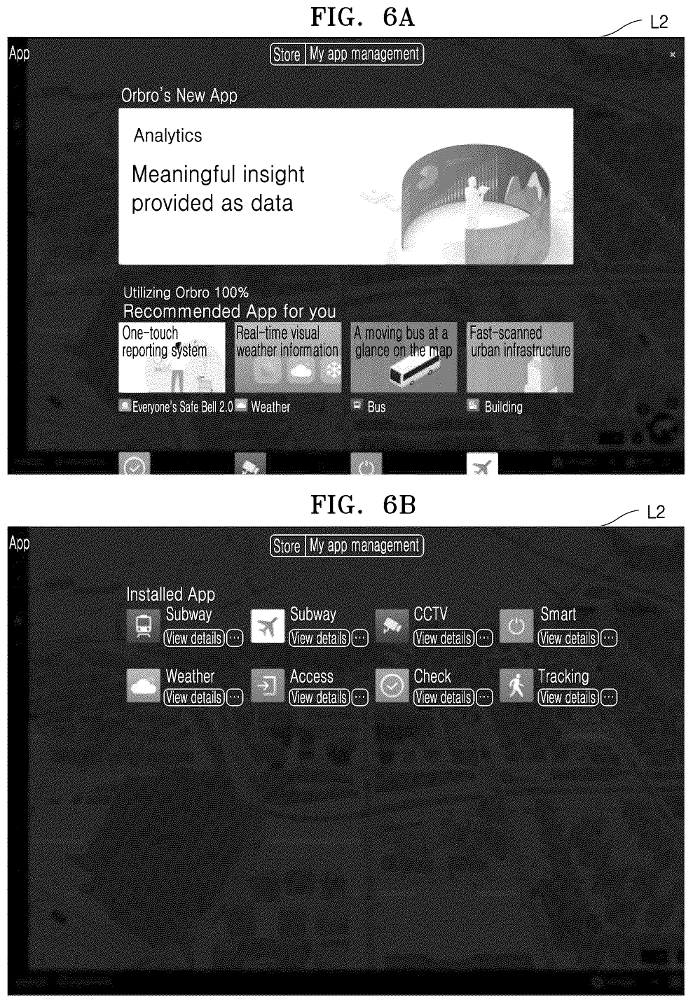

FIGS. 5A and 5B schematically show a map interface L1 displayed in a user terminal 4000 according to one embodiment of the present invention.

As shown in FIGS. 5A and 5B, the received map interface L1 may be displayed in the user terminal 4000 through the map interface providing step S200. As shown in FIGS. 5A and 5B, a total of three areas may be shown on the map interface L1. A first area may correspond to a menu area capable of calling various functions provided by the service server 1000, and the menu area may be shown on a leftmost side of the map interface L1, for example, as shown in FIG. 5A. Meanwhile, the menu area may be extended and shown according to a user's input as shown in FIG. 5B.

A second area may correspond to a 3D map area in which a 3D map with virtual objects projected thereon is shown in the map interface providing step S200, a plurality of projected virtual objects may be shown in the 3D map area, and the location of the virtual object shown on the 3D map may be applied in the same manner as the varied location of the corresponding reality object 2000 according to periodic reality information on the reality object 2000 corresponding to the corresponding virtual object. The 3D map area may be shown at a center of the map interface L1, for example, as shown in FIG. 5A.

A third area may correspond to a common app indication area in which icons capable of executing a predetermined number of applications are shown by comprehensively considering information on a currently displayed 3D map area, information on a rendering state of the 3D map for the corresponding area, and a plurality of virtual applications included in the currently displayed 3D map area. For example, referring to FIG. the common app indication area may show place name information on a currently displayed 3D map area such as “Bundang-gu, Seongnam-si, Gyeonggi-do”, information on a rendering state of a 3D map such as “100% connected,” etc. In addition, the common app indication area may be shown at a lower end of the map interface L1.

Meanwhile, the map interface L1 may show a predetermined area determined according to a user's input in the user terminal 4000 on the 3D map, and the movement of one or more virtual objects corresponding to the one or more reality objects 2000 may be shown on the 3D map on which the predetermined area is shown in real time based on the reality information on the one or more reality objects 2000 which move or enter within a real space corresponding to a predetermined area.

Specifically, as shown in FIGS. 5A and 5B, the 3D map shown on the 3D map area of the map interface L1 may not be fixed to a specific area, but the area of the 3D map may vary according to one or more inputs of the user to the user terminal 4000. For example, when the user terminal 4000 includes a touch display such as a smart phone, the user may change the area shown on the 3D map through an input such as pinch-out, pinch-in, drag, or the like on the touch display. Similarly, when the user terminal 4000 is connected to a traditional keyboard and mouse, the user may change the area shown on the 3D map through an input of drag, enlargement, and reduction through the mouse.

Meanwhile, as described above, when the area shown on the 3D map is changed according to the user's input on the map interface L1, the movement of one or more virtual objects corresponding to the one or more reality objects 2000 may be shown on the 3D map for the changed area in real time on the basis of the reality information on one or more reality objects 2000 disposed or moved within an area of the real space corresponding to the changed area in the 3D map, or entering the corresponding area.

Specifically, when the user performs an input of varying the area of the 3D map on the map interface L1, the map interface providing step S200 may be configured to project one or more virtual objects included in the varied area on the 3D map, and provide the user terminal 4000 with the map interface L1 including the 3D map for the varied area on which the one or more virtual objects are projected. In addition, the map interface providing step S200 may be repeatedly performed to periodically provide the user terminal 4000 with the map interface L1 including the 3D map in which the movement of one or more virtual objects within the varied area is reflected.

FIGS. 6A and 6B schematically show an app store layer L2 displayed in a user terminal 4000 according to a user's input on a map interface L1 according to one embodiment of the present invention.

As described above with reference to FIGS. 5A and 5B, when the map interface L1 provided to the user terminal 4000 includes a menu area and the user selects an “app” in the menu area shown in FIG. 5B, an app store array L2 may be displayed in the user terminal 4000.

As shown in FIG. 6A, a list of one or more applications usable in the user terminal 4000 may be shown in the app store array L2, and the user may select any one application shown in the list and set the corresponding application to be usable in the user terminal 4000.

Meanwhile, in one embodiment of the present invention, the application may correspond to software which may be directly installed in the user terminal 4000. Accordingly, when the user selects any one application to be set as usable through the app store array L2, the service server 1000 may provide an installation file for the selected application to the user terminal 4000, and the user terminal 4000 may execute the installation file to directly install the selected application in the user terminal 4000.

On the contrary, in another embodiment of the present invention, when the application is installed in the service server 1000 and the user selects any one application to be set as usable through the app store array L2, the service server 1000 may be configured to set the selected application to be usable for the corresponding user terminal 4000. In other words, it may be understood that the application in another embodiment of the present invention may correspond to a function provided by the service server 1000, and when the user selects the application, the selected application (function) is usable in the corresponding user terminal 4000.

Meanwhile, when “My app management” is selected in the app store array L2 shown in FIG. 6A, a separate app store array L2 shown in FIG. 6B may be displayed in the user terminal 4000. The separate app store array (L2) may show a list of one or more applications set to be usable by the user. Accordingly, the user may recognize the list of one or more applications that the user has set as usable through a separate app store array L2.

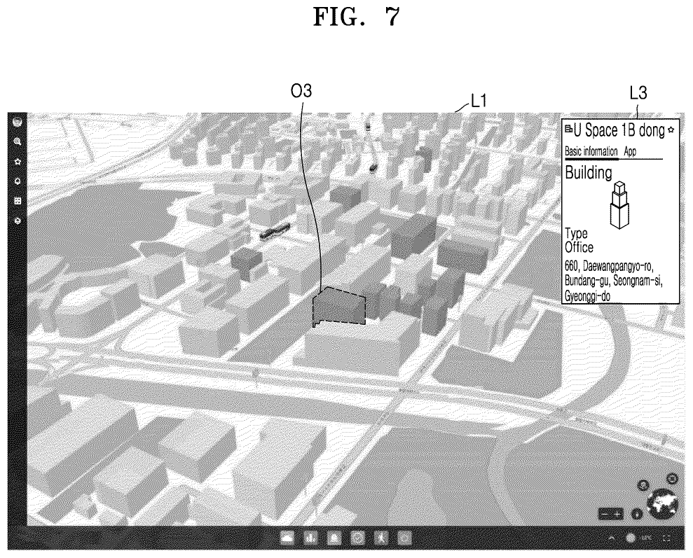

FIG. 7 schematically shows an object information layer L3 for any one virtual object O3 displayed in a user terminal 4000 when the corresponding virtual object shown on a 3D map of a map interface L1 is selected, according to one embodiment of the present invention.

As shown in FIG. 7, the user may select any one virtual object O3 on the 3D map of a map interface L1 displayed in the user terminal 4000, and when the any one virtual object O3 is selected, the selected virtual object O3 may be shown to be visually different from other objects, and the service server 1000 may be configured to derive an object information layer L3 for the selected virtual object O3 and provide the derived object information layer L3 to the user terminal 4000.

The object information layer L3 provided to the user terminal 4000 may be shown on the map interface layer L1 displayed in the user terminal 4000 while overlaying the object information layer, and the property (“office” in FIG. 7) of the corresponding virtual object O3 and detailed information of the corresponding virtual object O3 may be shown on the object information layer L3.

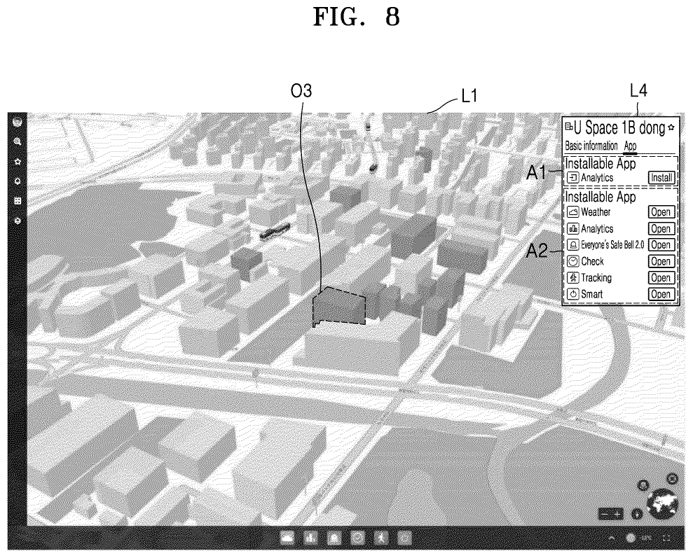

FIG. 8 schematically shows an app list layer L4 for any one virtual object O3 displayed in a user terminal 4000 when the corresponding virtual object O3 shown on a 3D map of a map interface L1 is selected, according to one embodiment of the present invention.

As described above with reference to FIG. 7, when the user selects “app” from the displayed object information layer L3 as the user selects the virtual object O3, an app list layer L4 including app list information derived through the app list layer providing step S300 may be provided to the user terminal 4000 as shown in FIG. 8.

The app list layer providing step S300 may be configured to show an app list layer L4 including the derived app list information on the 3D map of the map interface L1 displayed in the user terminal 4000 while overlaying the app list layer, and the app list layer L4 may include an execution proposal area A2 configured to show a list of one or more applications set by the user terminal 4000 among one or more applications connected to the selected virtual object O3, and an installation proposal area A1 configured to show a list of one or more applications not set by the user terminal 4000 among one or more applications connected to the selected virtual object O3.

Specifically, in the app list layer providing step S300, the app list layer L4 provided to the user terminal 4000 may be shown at a predetermined location (at an upper right end of FIG. 8) on the map interface L1 displayed in the user terminal 4000 while overlaying the app list layer. Through this configuration, there may be an effect of allowing the user to recognize the virtual object O3 selected by the user and the app list layer L4 for the selected virtual object O3 on one screen together.

Meanwhile, the app list layer L4 shown on the map interface L1 displayed in the user terminal 4000 through the app list layer providing step S300 while overlaying the app list layer may include an installation proposal area A1 and an execution proposal area A2.

The installation proposal area A1 may show a list of one or more applications, which are not set to be usable in the corresponding user terminal 4000, among the one or more applications connected to the virtual object O3 selected by the user, and the execution proposal area A2 may show a list of one or more applications, which are set to be usable in the corresponding user terminal 4000, among the one or more applications connected to the virtual object O3 selected by the user.

When the user selects an installation input for any one application from the list of one or more applications shown in the installation proposal area A1, the selected application may be set to be usable in the user terminal 4000. When the user selects an execution input for any one application from the list of one or more applications shown in the execution proposal area A2, the above-described service information providing step S400 may be performed to execute the selected any one application. As described above, unlike the conventional method of providing a service according to the execution of an application, the present invention may provide a service for a virtual object by selecting the virtual object O3 first and then selecting an executable application for the virtual object O3 through the app list layer L4, thereby exhibiting an effect of providing a service in a manner optimized for a user experience in an interface in which numerous objects such as a metaverse or a digital twin exist or objects become a core.

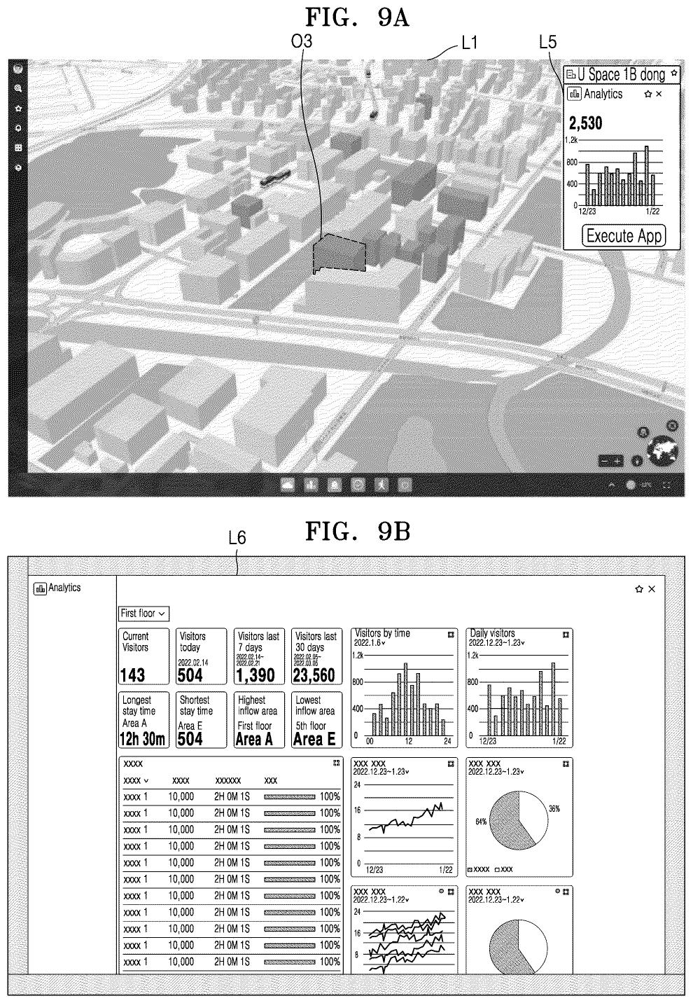

FIGS. 9A and 9B schematically show a service layer L5 displayed in a user terminal 4000 through a service information providing step S400 according to one embodiment of the present invention.

As shown in FIGS. 9A and 9B, the service information providing step S400 may include a service layer providing step of executing the selected application to derive service information for the selected virtual object O3 and providing a service layer L5 including the service information to the user terminal 4000, in which the service layer L5 may be shown on a map interface L1 displayed in the user terminal 4000 while overlaying the service layer.

Specifically, when any one of one or more applications included in the execution proposal area A2 of the app list layer L4 is selected, the service information providing step S400 may be performed to execute any of the selected application to derive service information on the selected virtual object O3, the derived service information may be included in the service layer L5, and the service layer L5 may be provided to the user terminal 4000.

As described above, the service layer L5 provided to the user terminal 4000 through the service information providing step S400 may be shown at a predetermined location (an upper right end in FIG. 9A) on the map interface L1 displayed in the user terminal 4000 while overlaying the service layer, as shown in FIG. 9A. Service information on the selected virtual object O3 may be shown on the service layer L5 as the selected application is executed. For example, when the user selects an application written as “Analytics” which provides a trend of the number of visitors who visit the reality object 2000 corresponding to the corresponding virtual object O3 in the execution proposal area A2 of the app list layer L4 of FIG. 8 as described above, the service information shown on the service layer L5 shown in FIG. 9A may correspond to trend information on the number of visitors who visit the reality object 2000 corresponding to the virtual object O3 with respect to the virtual object O3 selected by executing the application written as “Analytics.”

Meanwhile, as the user selects “Execute App” shown in FIG. 9A on the service layer L5 shown on the map interface L1 displayed in the user terminal 4000 through the service providing step while overlaying the service layer, a request for detailed service information for service information derived from the selected application may be input, and accordingly, the service information providing step S400 may provide the user terminal 4000 with a detailed service layer L6 on which the detailed service information is shown, and the detailed service layer L6 may be displayed in the user terminal 4000 as shown in FIG. 9B. More detailed information on the above-described service information may be shown on the detailed service layer L6, and the configuration of the detailed service layer L6 may be made differently according to the executed application.

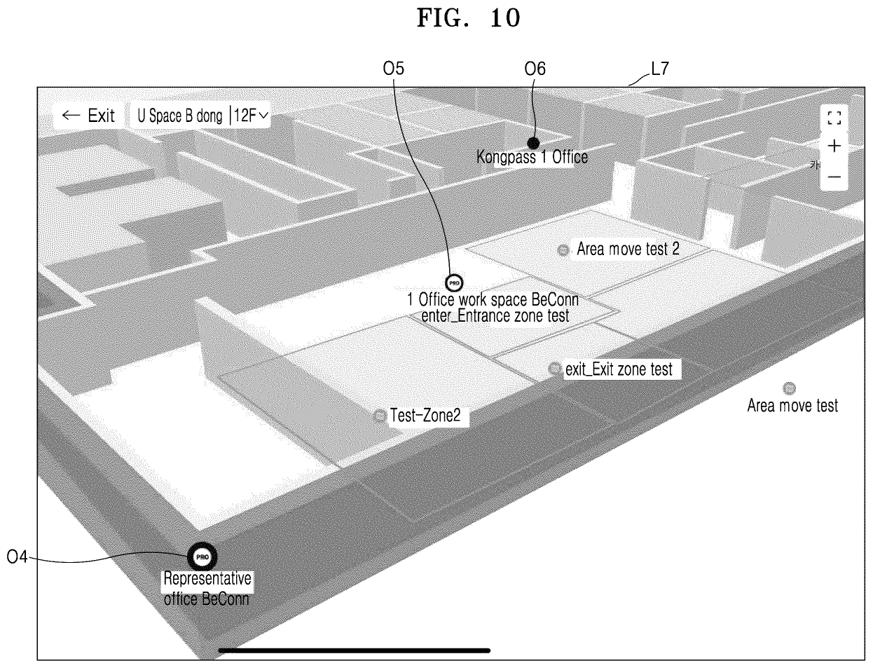

FIG. 10 schematically shows an indoor interface L7 displayed in the user terminal 4000 through an indoor interface providing step according to one embodiment of the present invention.

As shown in FIG. 10, the map interface providing step S200 may include an indoor interface providing step of providing the user terminal 4000 with an indoor interface L7 indicating an inside of any one virtual object having a building property, when any one virtual object having the building property is selected on the 3D map of the map interface L3 displayed in the user terminal 4000 and an entry for the any one virtual object having the building property is input, and the indoor interface L7 may show one or more detailed virtual objects O4, O5 and O6 corresponding to one or more detailed reality objects 2000 included inside the reality object 2000 corresponding to any one virtual object having the building property.

Specifically, as shown in FIGS. 7, 8, and 9(A), when the user selects a virtual object capable of providing an interface for an internal configuration of the reality object 2000, such as a virtual object having a building property, among a plurality of virtual objects shown on a 3D map of the map interface L1 displayed in the user terminal 4000, an indoor entry element (“enter” in FIGS. 7, 8, and 9(A)) capable of calling an indoor interface L7 for the selected virtual object may be shown on the 3D map of the map interface L1, preferably at an upper side of the selected virtual object. When the user selects the indoor entry element, an indoor interface L7 for the selected virtual object may be displayed in the user terminal 4000, as shown in FIG. 10.

Meanwhile, the virtual object in which the indoor entry element is shown on the 3D map according to the user's selection is not limited to the virtual object having the building property described above. For example, even if the virtual object with the indoor entry element shown on the 3D map has a structure property such as a subway station, or has other properties, when an indoor interface L7 for the virtual object VO1 exists, the indoor entry element may be displayed on the 3D map according to the user's selection for the corresponding virtual object.

More specifically, the map interface providing step S200 may include the indoor interface providing step, and the indoor interface providing step may be performed when the user selects the virtual object to select the indoor entry element displayed on the 3D map.

The indoor interface providing step, which is configured to derive an indoor interface L7 in which the inside of the virtual object selected by the user is shown and provide the indoor interface L7 to the user terminal 4000, may be displayed in the user terminal 4000. As shown in FIG. 10, the indoor interface L7 may show an internal structure of the virtual object selected by the user. The internal structure of the virtual object shown on the indoor interface L7 may be configured in a form of reflecting the internal structure of the reality object 2000 corresponding to the virtual object, and the internal structure of the virtual object shown on the indoor interface L7 may be configured based on the reality information on the reality object 2000 described above.

Meanwhile, the indoor interface L7 may show one or more detailed virtual objects O4, O5 and O6 at one or more predetermined locations of the internal structure shown, and the one or more detailed virtual objects O4, O5 and O6 may correspond to one or more detailed reality objects 2000 included inside the reality object 2000 corresponding to the virtual object, and the locations and shapes of the one or more detailed virtual objects O4, O5 and O6 may be determined based on the reality information on the one or more detailed reality objects 2000. Taking the indoor interface L7 shown in FIG. 10 as an example, a total of three virtual objects O4, O5, and O6 may be shown in the internal structure shown on the indoor interface L7, and the total of three virtual objects O4, O5, and O6 may correspond to a detailed reality object 2000 corresponding to an access control device disposed inside a reality object (building).

In addition, in one embodiment of the present invention, as described above with reference to FIGS. 7 and 8, when the user selects the detailed virtual objects O4, O5 and O6 shown on the indoor interface L7, the app list layer providing step S300 may be performed, and the app list layer providing step S300 may be shown on the indoor interface L7 displayed in the user terminal 4000 while overlaying the app list layer by deriving app list information for a list of one or more applications connected to the detailed virtual object selected by the user and providing the user terminal 4000 with the app list layer L4 including the app list information.

Meanwhile, in another embodiment of the present invention, as shown in FIG. 10, when the inside of the virtual object selected by the user is composed of a plurality of floors or composed of a plurality of areas, an area (“12F of U space B dong” in FIG. 10) capable of calling an internal structure of another floor or another area may be shown on the indoor interface L7 for the corresponding virtual object. When the user selects the corresponding area to select another floor or another area, the indoor interface L7 displayed in the user terminal 4000 may show the internal structure of another floor or another area selected by the user.

In addition, when an exit element (“exit” in FIG. 10) is shown on the indoor interface L7 and the user selects the exit element, the map interface L1 may be displayed again in the user terminal 4000.

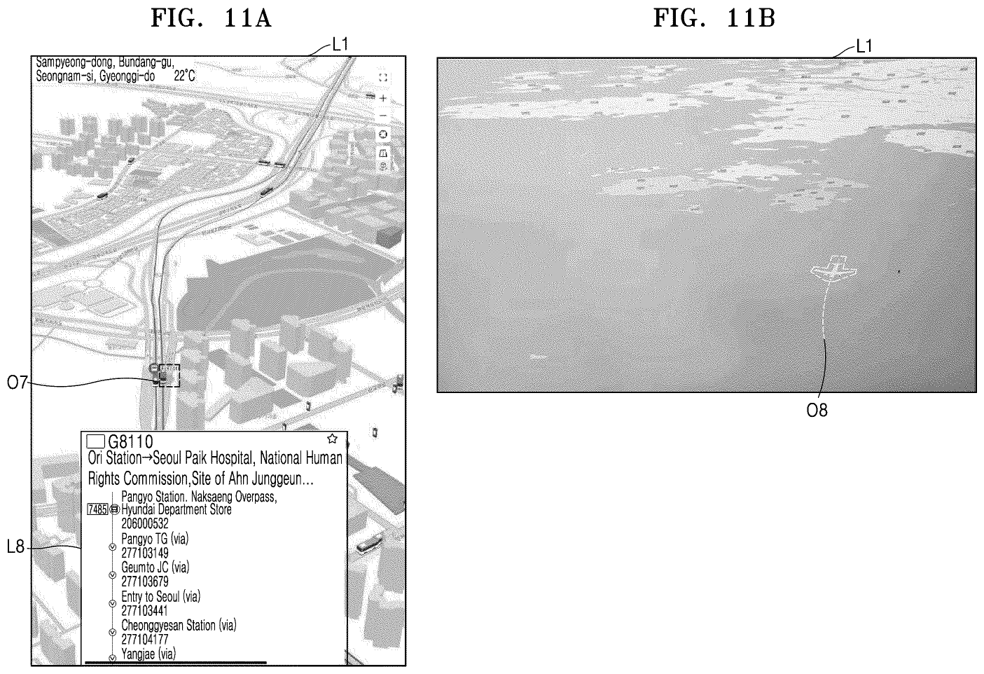

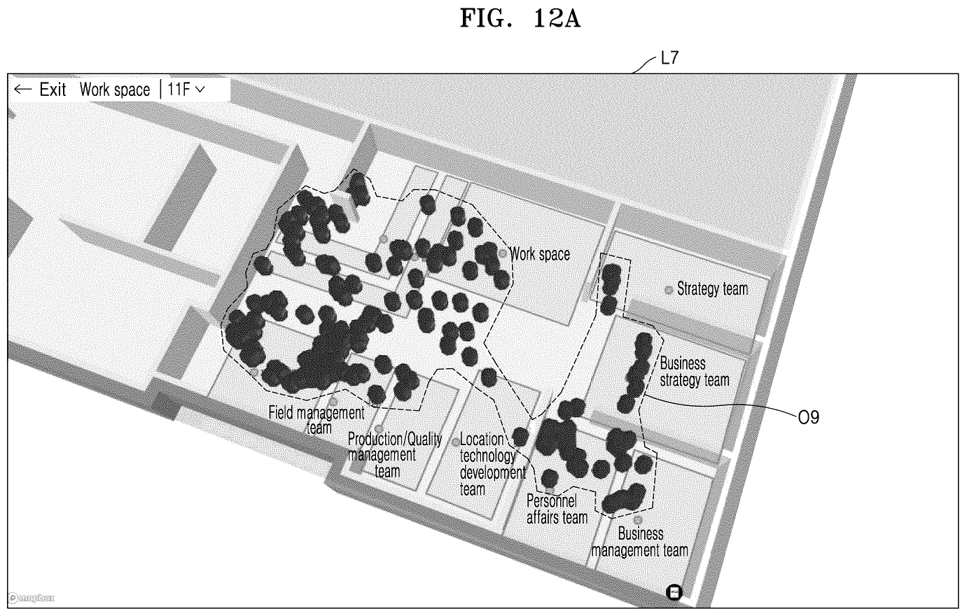

FIGS. 11A and 11B schematically show a virtual object shown on a 3D map of a map interface L1 displayed in a user terminal 4000 according to one embodiment of the present invention.

The drawing shown in FIGS. 11A and 11B schematically shows examples of virtual objects shown on a 3D map of the map interface L1.

FIG. 11A schematically shows a map interface L1 overlaid with a service layer L8 on which a selected application is executed and service information for a virtual object O7 is shown, when the user selects the virtual object O7 corresponding to the reality object 2000 for the bus shown on the 3D map of the map interface L1 and selects any one of one or more applications connected to the selected virtual object O7.

In FIG. 11A, it is shown that the user may select an application capable of seeing a real-time movement path of the virtual object (bus) O7, and the corresponding application may derive a real-time movement path (service information) for the virtual object (bus) O7 selected by the user, and the real-time movement path may be shown on the service layer L5.

Meanwhile, according to another embodiment of the present invention, if the number of applications connected to the virtual object O7 selected by the user is one, a list of applications connected to the map interface L1 may be shown, and the process of selecting any one application from the list by the user may be omitted, and one application connected to the virtual object O7 selected by the user may be automatically executed, so that service information according to the execution of the corresponding application may be shown on the service layer L5.

FIG. 11B schematically shows a map interface L1 in which a virtual object O8 corresponding to a reality object 2000 for an airplane is shown on a 3D map. As shown in FIG. 11B, in the case of the reality object 2000 in which a location of the reality object 2000 is not fixed and the location of the reality object is changed differently over time, the location of the virtual object O8 on the 3D map, on which the virtual object O8 for the corresponding reality object 2000 is shown, may also be changed and shown in real time according to a change in the location of the corresponding reality object 2000 based on the periodically received reality information of the reality object 2000.

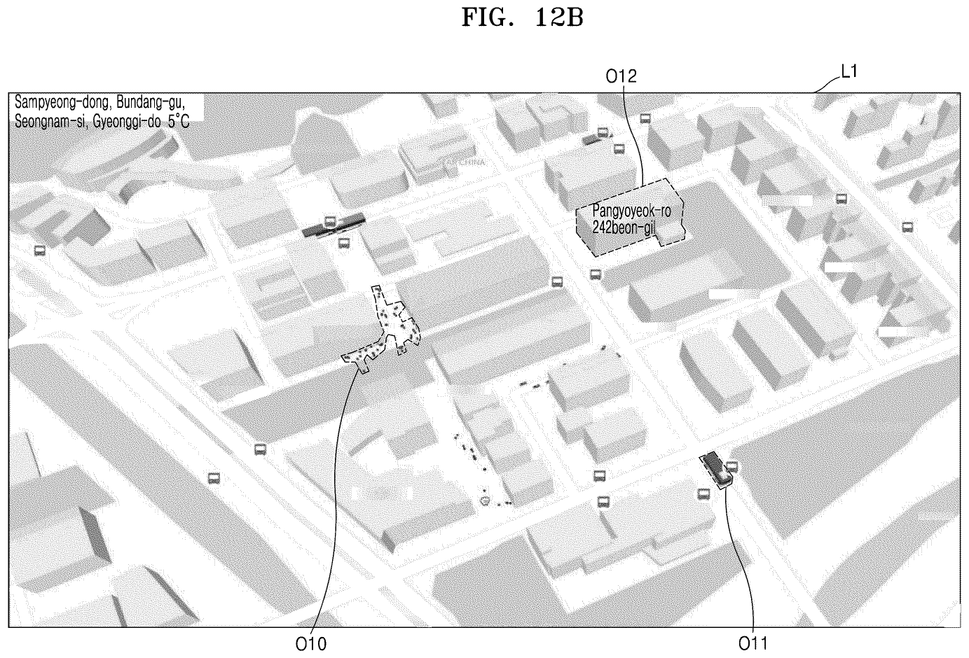

FIGS. 12A and 12B schematically show a virtual object O9 shown on a 3D map of an indoor interface L7 and a map interface L1 displayed in a user terminal 4000 according to one embodiment of the present invention.

FIG. 12A schematically shows a screen in which the indoor interface L7 of the virtual object selected by the user is displayed in the user terminal 4000. As shown in FIG. 12A, the indoor interface L7 shows detailed virtual object O9 for each of the visitors who current visit the inside of the reality object 2000 corresponding to the inside shown in the indoor interface L7.

At this time, in the case of the detailed virtual object O9 for the visitor, the reality information on the corresponding visitor may be transmitted through a mobile device such as a smart phone carried by the visitor or an external system 3000 communicating with the mobile device, the reality information receiving step S100 of the service server 1000 may receive the reality information, and the map interface providing step S200 may project the detailed virtual object O9 for the visitor on the internal structure shown on the indoor interface L7.

FIG. 12B schematically shows a map interface L1 in which a plurality of virtual objects O10, O11 and O12 are shown on a 3D map. An area shown on a 3D map of the map interface L1 displayed in the user terminal 4000 may vary according to a user's input, and a plurality of virtual objects located in an actual area for the corresponding area may be shown in the area shown on the 3D map. For example, in FIG. 12B, a virtual object O12 having a building property, a virtual object O11 having a transportation property, and a virtual object O10 having a person property are shown on a 3D map of the map interface L1.

As described above, the one or more virtual objects for the one or more reality objects 2000 located in a real area may be shown in real time on the 3D map of the map interface L1 with respect to the predetermined area displayed on the 3D map, and the one more detailed virtual objects for the one or more detailed reality objects 2000 located inside the reality objects 2000 corresponding to the selected virtual object may be shown in real time on the indoor interface L7 with respect to the virtual object selected by the user, and thus there may be provided an effect of allowing the user to grasp the locations of various objects in real time through the map interface L1 and the internal interface.

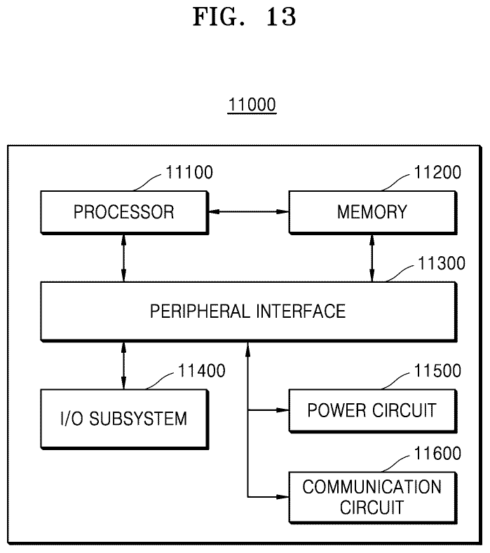

FIG. 13 schematically shows internal components of the computing device according to one embodiment of the present invention.

The service server 1000 shown in the above-described FIG. 1 may include components of the computing device 11000 shown in FIG. 13.

As shown in FIG. 13, the computing device 11000 may at least include at least one processor 11100, a memory 11200, a peripheral device interface 11300, an input/output subsystem (I/O subsystem) 11400, a power circuit 11500, and a communication circuit 11600. The computing device 11000 may correspond to the computing device 1000 shown in FIG. 1.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 11000.

The access to the memory 11200 from other components of the processor 11100 or the peripheral interface 11300, may be controlled by the processor 11100.

The peripheral interface 11300 may combine an input and/or output peripheral device of the computing device 11000 to the processor 11100 and the memory 11200. The processor 11100 may execute the software module or the instruction set stored in memory 11200, thereby performing various functions for the computing device 11000 and processing data.

The input/output subsystem may combine various input/output peripheral devices to the peripheral interface 11300. For example, the input/output subsystem may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or any other components for generating, managing, and distributing the power.

The communication circuit 11600 may use at least one external port, thereby enabling communication with other computing devices.

Alternatively, as described above, if necessary, the communication circuit 11600 may transmit and receive an RF signal, also known as an electromagnetic signal, including RF circuitry, thereby enabling communication with other computing devices.

The above embodiment of FIG. 13 is merely an example of the computing device 11000, and the computing device 11000 may have a configuration or arrangement in which some components shown in FIG. 13 are omitted, additional components not shown in FIG. 13 are further provided, or at least two components are combined. For example, a computing device for a communication terminal in a mobile environment may further include a touch screen, a sensor or the like in addition to the components shown in FIG. 13, and the communication circuit 11600 may include a circuit for RF communication of various communication schemes (such as WiFi, 3G, LTE, Bluetooth, NFC, and Zigbee). The components that may be included in the computing device 11000 may be implemented by hardware, software, or a combination of both hardware and software which include at least one integrated circuit specialized in a signal processing or an application.

The methods according to the embodiments of the present invention may be implemented in the form of program instructions to be executed through various computing devices, thereby being recorded in a computer-readable medium. In particular, a program according to an embodiment of the present invention may be configured as a PC-based program or an application dedicated to a mobile terminal. The application to which the present invention is applied may be installed in the computing device 11000 through a file provided by a file distribution system. For example, a file distribution system may include a file transmission unit (not shown) that transmits the file according to the request of the computing device 11000.

The above-mentioned device may be implemented by hardware components, software components, and/or a combination of hardware components and software components. For example, the devices and components described in the embodiments may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, some cases may have described that one processing device is used, however, it is well known by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, and an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, computer storage medium or device, or in a signal wave to be transmitted. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms, thereby being recorded in a computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like as well as a machine code generated by a compiler. The above hardware device may be configured to operate as at least one software module to perform the operations of the embodiments, and vise versa.

According to one embodiment of the present invention, when a virtual object shown on a 3D map of a map interface is selected, an app list layer, in which app list information on one or more applications connected to the selected virtual object is shown, can be provided to a user terminal so as to be displayed, thereby exhibiting an effect of providing a service according to the execution of an application on the basis of the object.

According to one embodiment of the present invention, reality information on a plurality of reality objects in reality can be received, virtual objects corresponding to the reality objects can be generated according to the reality information and shown on the 3D map, and the shapes and locations of the reality objects included in the reality information can be reflected on the 3D map, thereby exhibiting an effect of allowing a user using the 3D map to feel a sense of reality.

According to one embodiment of the present invention, the app list layer providing step can show the app list layer on the 3D map of the map interface displayed in the user terminal while overlaying the app list, thereby exhibiting an effect of allowing the user to more conveniently recognize the virtual object shown on the 3D map of the map interface and the app list layer for the corresponding virtual object.

According to one embodiment of the present invention, the service information providing step can execute a selected application to derive service information on the selected virtual object and overlay a service layer including the service information onto the map interface displayed in the user terminal, when any one application shown on the app list layer is selected, thereby exhibiting an effect of performing all the processes of allowing the user to select a virtual object on the map interface, select any one application related to the virtual object, and receive the service information.

According to one embodiment of the present invention, the app list layer can include an installation proposal area which shows one or more applications, which are not installed in the user terminal, from among one or more applications connected to the selected virtual object, thereby exhibiting an effect of being recommended an application which is not installed in the user terminal among one or more applications connected to the virtual object selected by the user.

According to one embodiment of the present invention, the map interface providing step can show an indoor interface for an inside of a selected virtual object and a detailed virtual object included therein, when a virtual object having a building property is selected on a 3D map and an entry for the virtual object is input, thereby exhibiting an effect of allowing the user to see an inside of the building selected by the user and the objects contained therein.

Although the above embodiments have been described with reference to the limited embodiments and drawings, however, it will be understood by those skilled in the art that various changes and modifications may be made from the above-mentioned description. For example, even though the described descriptions may be performed in an order different from the described manner, and/or the described components such as system, structure, device, and circuit may be coupled or combined in a form different from the described manner, or replaced or substituted by other components or equivalents, appropriate results may be achieved.

Therefore, other implementations, other embodiments, and equivalents to the claims are also within the scope of the following claims.

What is claimed is:

1. A method for providing an object-oriented application execution interface, which is performed in a service server comprising one or more processors and one or more memories, the method comprising:
a reality information receiving step of receiving reality information on each of a plurality of reality objects from the plurality of real objects in reality or an external system communicating with the plurality of reality objects;
a map interface providing step of providing a user terminal with a map interface in which a virtual object reflecting a shape and location of the reality object is displayed on a 3D map based on reality information on each of the corresponding reality objects;
an app list layer providing step of deriving app list information on one or more applications connected to any one selected virtual object and providing the user terminal with an app list layer including the app list information, when the virtual object shown on the map interface displayed in the user terminal; and
a service information providing step of executing any one application when the selected application is selected on the app list layer displayed in the user terminal through the app list layer providing step.

2. The method of claim 1, wherein the app list layer providing step
derives the app list information on one or more applications determined based on property of the selected virtual object among a plurality of applications usable in the user terminal.

3. The method of claim 1, wherein the app list layer providing step
displays the app list layer comprising the derived app list information on a 3D map of the map interface displayed in the user terminal while overlaying the app list on the 3D map of the map interface.

4. The method of claim 1, wherein the service information providing step comprises:
a service layer providing step of executing the selected application to derive service information for the selected virtual object and provide a service layer including the service information to the user terminal, wherein
the service layer
is shown on the map interface displayed in the user terminal while overlaying the service layer.

5. The method of claim 1, wherein the app list layer comprises:
an execution proposal area configured to display a list of one or more applications set from the user terminal among the one or more applications connected to the selected virtual object; and
an installation proposal area configured to display a list of one or more applications not set from the user terminal among the one or more applications connected to the selected virtual object.

6. The method of claim 1, wherein the map interface
displays a predetermined area determined according to a user's input in the user terminal on the 3D map, and
the 3D map with the predetermined area shown thereon
shows movements of one or more virtual objects corresponding to one or more reality objects in real time based on the reality information on the one or more reality objects which move or enter in a real space corresponding to the predetermined area.

7. The method of claim 1, wherein the map interface providing step comprises:
an indoor interface providing step of providing the user terminal with an indoor interface for indicating an inside of any one virtual object having a building property when the any one virtual object having the building property is selected on the 3D map of the map interface displayed in the user terminal and entry for the any one virtual object having the building property is input, wherein
the indoor interface
is configured to show one or more detailed virtual objects corresponding to one or more detailed reality objects included inside a reality object corresponding to any one virtual object having the building property.

8. A service server for performing an object-oriented application execution interface, comprising one or more processors and one or more memories, wherein the service server performs:
a reality information receiving step of receiving reality information on each of a plurality of reality objects from the plurality of real objects in reality or an external system communicating with the plurality of reality objects;
a map interface providing step of providing a user terminal with a map interface in which a virtual object reflecting a shape and location of the reality object is displayed on a 3D map based on reality information on each of the corresponding reality objects;
an app list layer providing step of deriving app list information on one or more applications connected to any one selected virtual object and providing the user terminal with an app list layer including the app list information, when the virtual object shown on the map interface displayed in the user terminal; and
a service information providing step of executing any one application when the selected application is selected on the app list layer displayed in the user terminal through the app list layer providing step.

9. A computer-readable medium method for implementing an object-oriented application execution interface, which is performed in a service server comprising one or more processors and one or more memories, wherein the computer-readable medium comprises computer-executable instructions for causing the service server to perform steps as follows:
a reality information receiving step of receiving reality information on each of a plurality of reality objects from the plurality of real objects in reality or an external system communicating with the plurality of reality objects;
a map interface providing step of providing a user terminal with a map interface in which a virtual object reflecting a shape and location of the reality object is displayed on a 3D map based on reality information on each of the corresponding reality objects;
an app list layer providing step of deriving app list information on one or more applications connected to any one selected virtual object and providing the user terminal with an app list layer including the app list information, when the virtual object shown on the map interface displayed in the user terminal; and
a service information providing step of executing any one application when the selected application is selected on the app list layer displayed in the user terminal through the app list layer providing step.
